(19) United States
(12) Patent Application Publication
(10) Pub. No.: US 2026/0282098 A1
(43) Pub. Date: Sep. 17, 2026

(54) COMMUNICATION APPARATUSES AND COMMUNICATION METHODS FOR A MULTI-PHYSICAL RANDOM ACCESS CHANNEL TRANSMISSION

(71) Applicant: Panasonic Intellectual Property Corporation of America, Torrance, CA (US)

(72) Inventors: Xuan Tuong TRAN, Singapore (SG); Yang KANG, Singapore (SG); Hidetoshi SUZUKI, Kanagawa (JP); Yoshihiko OGAWA, Kanagawa (JP)

(73) Assignee: Panasonic Intellectual Property Corporation of America, Torrance, CA (US)

(21) Appl. No.: 19/166,372

(22) PCT Filed: Jan. 12, 2024
(86) PCT No.: PCT/SG2024/050029

§ 371 Date: Sep. 17, 2025

(30) Foreign Application Priority Data
Apr. 6, 2023 (SG) 10202300967R
Apr. 17, 2023 (SG) 10202301066X

(51) Int. Cl. H04W 74/0833; H04L 5/00

(52) U.S. Cl. CPC H04W 74/0833; H04L 5/0005

(57) ABSTRACT

The present disclosure provides communication apparatuses and communication methods for random access radio network temporary identifier (RA-RNTI) calculation for handling Random Access Channel Occasion (RO) Collision in a multi-physical Random Access Channel (multi-PRACH) transmission. The communication apparatuses include a communication apparatus comprising: circuitry, which in operation, determines one or more random access radio network temporary identifiers (RA-RNTIs) based on a first plurality of resources and/or a second plurality of resources of a Random Access Channel Occasions (RO) group; a transmitter, which in operation, transmits a preamble in at least one of the first plurality of resources; and a receiver, which in operation, receives downlink control information (DCI) with cyclic redundancy check (CRC) scrambled by the one or more RA-RNTIs in response to the preamble transmission.

### TECHNICAL FIELD

The present disclosure relates to communication apparatuses and communication methods. In particular, it may relate to communication apparatuses and communication methods for a multi-physical Random Access Channel (multi-PRACH) transmission.

### BACKGROUND

In Releases 15, 16 and 17 of relevant 3GPP technical specifications (TSs), for example, in 3GPP TS 38.321 version 17.3.0 Release 17, a single Physical Random Access Channel (single-PRACH) transmission may be used. A user equipment (UE) may send a preamble (e.g., via Msg1) in one Random Access Channel (RACH) occasion (RO) to a base station (e.g., gNB) to get uplink (UL) synchronization in a single-PRACH transmission. Each preamble transmission is associated with a random access radio network temporary identifier (RA-RNTI), which is used for determining random-access response (RAR) data (i.e., Msg2) during random access procedure. Particularly, this RO can be used to calculate (see clause 5.1.3) a RA-RNTI. The calculation of RA-RNTI is known by both UE and gNB. gNB later sends a RAR (Msg2) to the UE as a response to the preamble transmission that was sent by the UE. The UE attempts to detect a DCI with CRC scrambled by the above calculated RA-RNTI within a RAR window. A length of the RAR window is configurable by higher-layer parameter ra-ResponseWindow. When the UE successfully decodes the DCI, it decodes the PDSCH carrying RAR. Moreover, it has been identified that PRACH is a bottleneck channel in term of coverage performance in new radio (NR). Therefore, in Release 18, to enhance coverage performance of PRACH, there is an ongoing discussion to support a multi-PRACH transmission in the 3rd Generation Partnership Project (3GPP) physical layer working group (also known as 3GPP RAN1). In particular, a UE can be configured to send multiple PRACH transmissions by using (a RO group for a specific number of multiple PRACH transmissions. The RO group may include either shared RO(s) or separated RO(s). That is, the RO group does not include both shared and separated ROs. The shared RO(s) may refer to ROs that are shared for both single-PRACH transmission and multi-PRACH transmission. The separated RO(s) may mean that ROs for a single-PRACH transmission are separated from ROs for a multi-PRACH transmission.

For both single-PRACH and multi-PRACH transmission cases, currently, a RO may be dropped due to an event of RO collision. For example, a RO may collide with another channel or signal because resources for the RO and another channel or signal in the downlink or uplink can be separately configured with different time-domain patterns. In such a case, one or more ROs in a RO group may be dropped due to event(s) of RO collision, and the one or more dropped ROs cannot be used for actual PRACH transmissions(s) for the multi-PRACH transmission. For half-duplex UE in paired band, gNB might not be aware of the certain number of dropped ROs because of HD-UE's implementation matter, and the certain number of dropped ROs can be different between HD-UEs. In another case, a UE can determine some valid ROs for actual PRACH transmissions, however, one of actual PRACH transmissions cannot be reached to gNB due to channel fading. From gNB perspective, it might assume the failed PRACH transmission in the corresponding RO as an invalid RO or a dropped RO. The above reasons may cause a misalignment between calculations of RA-RNTI at UE side and gNB side, where UE and gNB might calculate RA-RNTI candidates based on two different ROs. The misalignment between calculations of RA-RNTI at UE side and gNB side may result in a failed decoding of RAR at UE and other problems in consequence such as potential increase of power consumption at UE for a retransmission.

Thus, there is a need to provide communication apparatuses and methods for calculating RA-RNTI that resolve above problems in the multi-PRACH transmission.

### SUMMARY

Non-limiting and exemplary embodiments facilitate providing communication apparatuses and methods for RA-RNTI calculation handling RO collision in a multi-PRACH transmission.

According to a first embodiment of the present disclosure, there is provided a communication apparatus comprising: circuitry, which in operation, determines one or more random access radio network temporary identifiers (RA-RNTIs) based on a first plurality of resources and/or a second plurality of resources of a Random Access Channel Occasions (RO) group; a transmitter, which in operation, transmits a preamble in at least one of the first plurality of resources; and a receiver, which in operation, receives downlink control information (DCI) with cyclic redundancy check (CRC) scrambled by the one or more RA-RNTIs in response to the preamble transmission.

According to a second embodiment of the present disclosure, there is provided a first communication apparatus comprising: a receiver, which in operation, receives a preamble in at least one of a first plurality of resources of a Random Access Channel Occasions (RO) group from a second communication apparatus; circuitry, which in operation, determines one or more random access radio network temporary identifiers (RA-RNTIs) based on the first plurality of resources and/or a second plurality of resources, and generates a downlink control information (DCI) with cyclic redundancy check (CRC) scrambled by the one or more RA-RNTIs; and a transmitter, which in operation, transmits the DCI to the second communication apparatus

According to a third embodiment of the present disclosure, there is provided a communication method comprising: determining one or more random access radio network temporary identifiers (RA-RNTIs) based on a first plurality of resources and/or a second plurality of resources of a Random Access Channel Occasions (RO) group; transmitting a preamble in at least one of the first plurality of resources; and receiving a downlink control information (DCI) with cyclic redundancy check (CRC) scrambled by the one or more RA-RNTIs in response to the preamble transmission.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR radio access network (NR-RAN) architecture to which exemplary embodiments of the present disclosure can be applied.

FIG. 2 depicts a schematic drawing which shows functional split between NG-RAN and 5G Core Network (5GC) to which exemplary embodiments of the present disclosure may be applied.

FIG. 3 depicts a sequence diagram for RRC (radio resource control) connection setup/reconfiguration procedures to which exemplary embodiments of the present disclosure may be applied.

FIG. 4 depicts a schematic drawing showing usage scenarios of Enhanced mobile broadband (eMBB), Massive Machine Type Communications (mMTC) and Ultra Reliable and Low Latency Communications (URLLC) to which exemplary embodiments of the present disclosure may be applied.

FIG. 5 shows a block diagram showing an exemplary 5G system architecture for vehicle to everything (V2X) communication in a non-roaming scenario to which exemplary embodiments of the present disclosure may be applied.

FIG. 6 shows an exemplary illustration of a RO group for 4 PRACH transmissions in which a RO is dropped according to the current technical specifications.

FIG. 7 shows an exemplary illustration of a RA-RNTI calculation based on an invalid RO according to various embodiments of the present disclosure.

FIG. 8 shows an exemplary illustration of a RA-RNTI calculation based on a plurality of ROs according to various embodiments of the present disclosure.

FIG. 9 shows an exemplary illustration of a RA-RNTI calculation based on dedicated time and frequency domain resources according to various embodiments of the present disclosure.

FIG. 10 shows a flow chart for a UE according to various embodiments of the present disclosure.

FIG. 11 shows a flow chart for a gNB according to various embodiments of the present disclosure.

FIG. 12 shows an exemplary illustration of a 4-step random access (RA) procedure for a multi-PRACH transmission according to various embodiments of the present disclosure.

FIG. 13 shows a flow chart illustrating a communication method according to various embodiments of the present disclosure.

FIG. 14 shows a schematic block diagram of an exemplary communication apparatus in accordance with a single antenna with various embodiments of the present disclosure.

FIG. 15 shows a schematic block diagram of an exemplary communication apparatus with multiple antennas in accordance with various embodiments of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

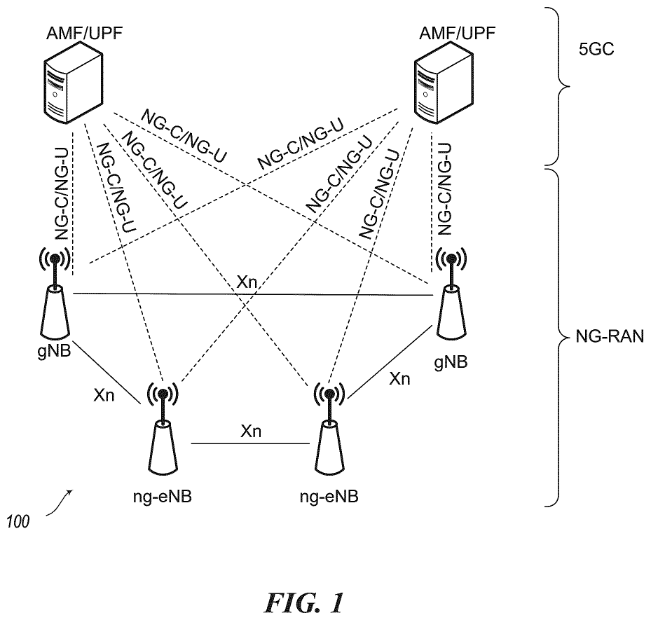

Among other things, the overall system architecture assumes an NG-RAN (Next Generation—Radio Access Network) that comprises gNBs, providing the NG-radio access user plane (SDAP/PDCP/RLC/MAC/PHY) and control plane (RRC) protocol terminations towards the user equipment (UE). The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture 100 is illustrated in FIG. 1 (see e.g., 3GPP TS 38.300 v16.3.0, section 4).

The user plane protocol stack for NR (see e.g., 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g., sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300. Further, sidelink communications is introduced in 3GPP TS 38.300 v16.3.0. Sidelink supports UE-to-UE direct communication using the sidelink resource allocation modes, physical-layer signals/channels, and physical layer procedures (see for instance section 5.7 of TS 38.300).

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are Physical Random Access Channel (PRACH), Physical Uplink Shared Channel (PUSCH) and Physical Uplink Control Channel (PUCCH) for uplink and Physical Downlink Shared Channel (PDSCH), Physical Downlink Control Channel (PDCCH) and Physical Broadcast Channel (PBCH) for downlink. Further, physical sidelink channels include Physical Sidelink Control Channel (PSCCH), Physical Sidelink Shared Channel (PSSCH), Physical Sidelink Feedback Channel (PSFCH) and Physical Sidelink Broadcast Channel (PSBCH).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than a mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

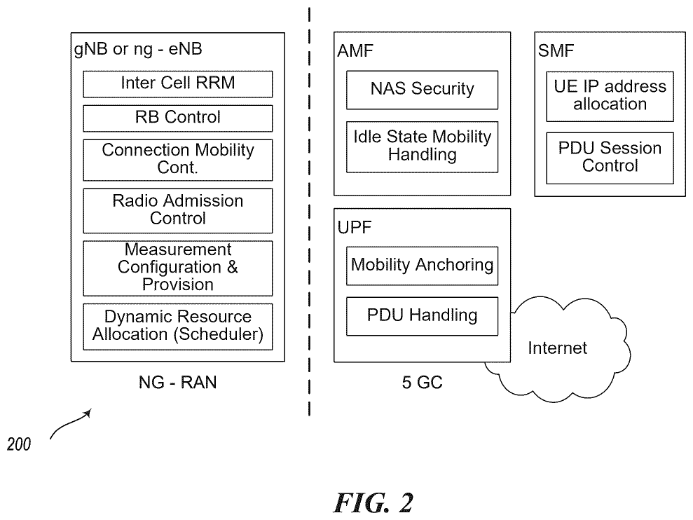

Schematic drawing 200 of FIG. 2 illustrates functional split between NG-RAN and 5GC. NG-RAN logical node is a gNB or ng-eNB. The 5GC has logical nodes Access and Mobility Management Function (AMF), User Plane Function (UPF) and Session Management Function (SMF).

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility:
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

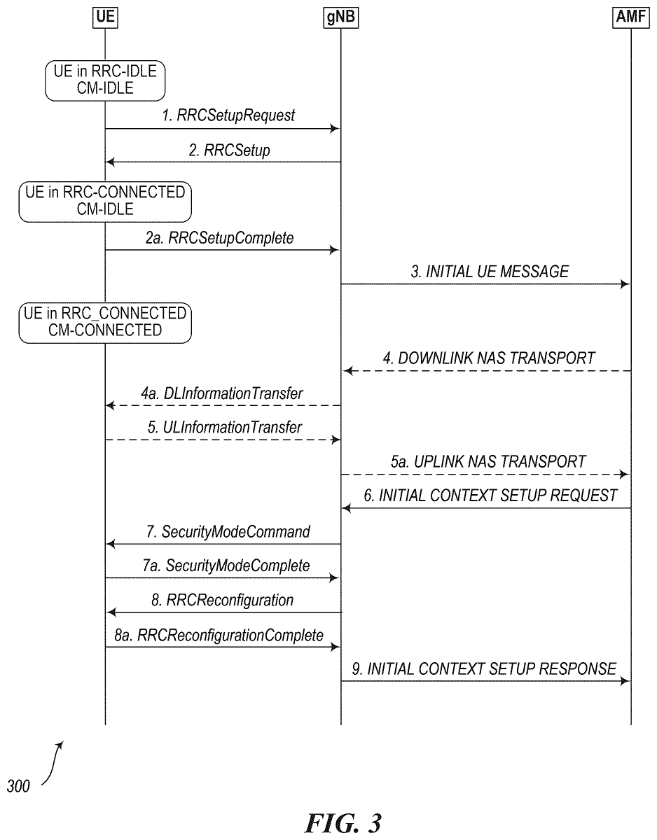

Sequence diagram 300 in FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502 reference [22](3GPP TS 23.122: “Non-Access-Stratum (NAS) functions related to Mobile Station in idle mode”).
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signalling (protocol) used for UE and gNB configuration. In particular, this transition involves that the AMF prepares the UE context data (including e.g., PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

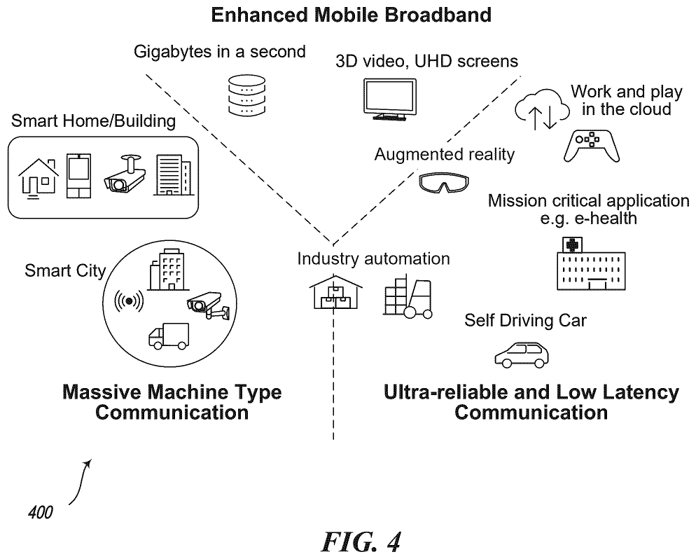

Schematic drawing 400 in FIG. 4 illustrates some use cases for 5G NR. In third generation partnership project new radio (3GPP NR), three use cases are being considered that have been envisaged to support a wide variety of services and applications by IMT-2020. The technical specification (TS) for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 4 illustrates some examples of envisioned usage scenarios for IMT for 2020 and beyond (see e.g., ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1 E−5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, mini-slot-based scheduling with flexible mapping, grant free (configured grant) uplink, mini-slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated Channel Quality Indicator/Modulation and Coding Scheme (CQI/MCS) tables for the target BLER of 1 E−5.

The use case of mMTC (massive machine-type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few μs where the value can be one or a few μs depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and channel state information (CSI) feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g., as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

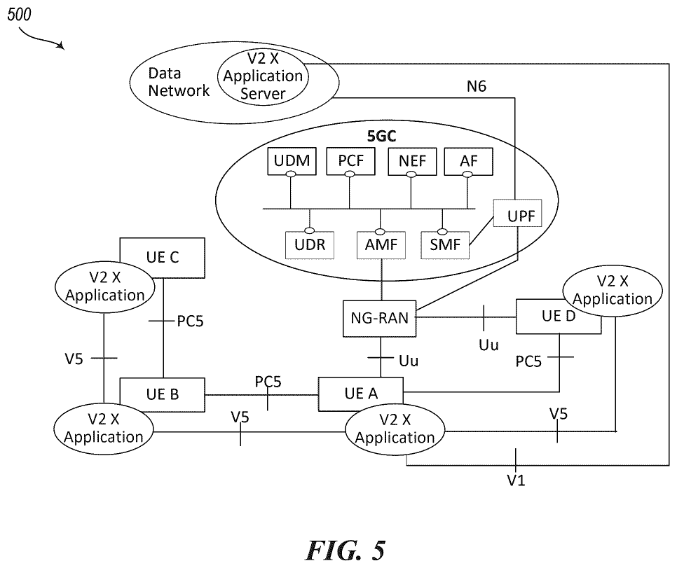

Block diagram 500 in FIG. 5 illustrates a 5G NR non-roaming reference architecture (see TS 23.287 v16.4.0, section 4.2.1.1). An Application Function (AF), e.g., an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g., QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or third party services. All of or a part of the core network functions and the application services may be deployed and running on cloud computing environments.

In the current technical specifications, a user equipment (UE) sends a preamble (e.g., Msg1) over a physical Random-Access Channel (PRACH) channel to a base station (gNB) to get uplink (UL) synchronization in a single-PRACH transmission scenario. Each preamble transmission (e.g., a RACH occasion (RO)) is associated with a RA-RNTI candidate which is calculated based on a RO of a single-PRACH transmission according to the following equation RA-RNTI=1+s_id+14×t_id4×80×f_id+14×80×8×ul_carrier_id in TS 38.321, where s_id is the index of the first OFDM symbol of the PRACH occasion (0≤s_id<14), t_id is the index of the first slot of the PRACH occasion in a system frame (0≤t_id<80), f_id is the index of the PRACH occasion in the frequency domain (0≤f_id<8), and ul_carrier_id is the UL carrier used for PRACH preamble transmission (0 for normal uplink (NUL) carrier, and 1 for supplementary uplink (SUL) carrier). The s_id, t_id and f_id are herein referred to as a plurality of indexes of a resource (e.g., time and frequency resource) of a RO. The gNB later sends a RAR (e.g., Msg2) to the UE as a response to the preamble transmission that was sent by the UE. The UE attempts to detect a DCI with a cyclic redundancy check (CRC) that is scrambled by the above calculated RA-RNTI within a RAR window (e.g., a length of the RAR window is configurable by higher-layer parameter ra-ResponseWindow). When the UE successfully decodes the DCI, it decodes the PDSCH carrying RAR. The calculation of RA-RNTI candidate is known by both the UE and gNB.

For multi-PRACH transmission case in Rel. 18 technical specifications, it has been agreed recently that a RO group is introduced for a specific number of multiple PRACH transmissions. A RO group may include either shared RO(s) only or separate RO(s) only, but it cannot include both shared and separate ROs (e.g., a shared or separate RO means that a RO is shared with or separated from single PRACH transmission use cases). A UE can send multiple PRACH transmissions by using a RO group for a specific number of multiple PRACH transmissions. Only one RAR window is supported for RAR monitoring in one RACH attempt of a multi-PRACH transmission. It is not concluded how to calculate RA-RNTI for a multi-PRACH transmission, as shown in the following agreement under Rel.18 technical specification: for multiple PRACH transmissions with same transmit (Tx) beam, only one RAR window is supported for RAR monitoring for one RACH attempt, wherein the start position of the RAR window and the calculation of RA-RNTI are for further study (FFS). It will be appreciated that a “RO group” may also be referred to herein as a RO grouping, or a set of ROs, or a group of ROs, or a “RO bundle”, or a “RO bundling”.

At present, a RO may collide with another channel or signal because resources of the RO and the another channel or signal in the downlink or uplink can be separate configurations with different time-domain patterns (e.g., a collision event that occurs within a UE and not an over the air collision). For a UE in an unpaired band, a RO may be dropped due to a collision with SSB, for example based on the following RO dropping rules (e.g., under Clause 8.1, TS 38.213): (1) if a UE is not provided tdd-UL-DL-ConfigurationCommon and if a RO does precede a synchronization signal block (SSB) in the PRACH slot and starts at least N_{gap} symbols after a last SSB reception symbol, where N_{gap} is provided in Table 8.1-2 and, if channelAccessMode=“semiStatic” is provided, the RO overlaps with a set of consecutive symbols before the start of a next channel occupancy time where the UE does not transmit [Clause 15, TS 37.213]; and (2) if a UE is provided tdd-UL-DL-ConfigurationCommon and if a RO does precede a SSB in the PRACH slot and starts at least N_{gap} symbols after a last downlink symbol and at least N_{gap} symbols after a last SSB, and if channelAccessMode=“semiStatic” is provided, the RO overlaps with a set of consecutive symbols before the start of a next channel occupancy time where there shall not be any transmissions. For half-duplex UE (HD-UE) in paired band, a RO can be dropped or kept due to a collision with SSB or another signal/channel, based on the following RO dropping rule or HD-UE's implementation [Clause 17.2, TS 38.213]: (1) if a HD-UE transmits a PRACH based on a detected DCI format and the HD-UE is indicated a presence of SSB in a set of symbols, the HD-UE does not transmit PUSCH or PUCCH or PRACH if a transmission would overlap with any symbol from the set of symbols; (2) if a HD-UE transmits a PRACH or MsgA PUSCH triggered by higher layers in a set of symbols and receives a PDCCH, or a PDSCH, or a channel state information reference signal (CSI-RS), or a DL positioning reference signal (PRS), or is indicated presence of SSB in symbols that include any symbol from the set of symbols, the HD-UE can select based on its implementation whether to either transmit the PRACH or the MsgA PUSCH or receive the PDSCH, or the CSI-RS, or the physical layer (PL) RS, or the PDCCH, or the SSB; (3) if a HD-UE receives a PDCCH, or a PDSCH, or a CSI-RS, or a DL PRS based on a configuration by higher layers or is indicated presence of SSB in a set of symbols, and the HD-UE transmits PRACH or MsgA PUSCH triggered by higher layers starting or ending at a symbol that is earlier or later than N_{Rx-Tx}. T_{c} or N_{Tx-Rx}. T_{c}, respectively, from the last or first symbol in the set of symbols, the HD-UE can select based on its implementation whether to either transmit the PRACH or the MsgA PUSCH or receive the PDSCH, or the CSI-RS, or the DL PRS, or the PDCCH, or the SSB. Note that N_{Rx_Tx}, N_{Rx_Tx}, and T_{c} are specified in TS 38.213. The above RO dropping (due to a collision) holds true for both single-PRACH transmission and multi-PRACH transmission. For a multi-PRACH transmission case, there may be additional collision between ROs (e.g., especially for separate ROs) in a RO group and other features (e.g., 2-step RACH), such that one or more ROs in a RO group may be dropped. This implies that a number of valid ROs for actual PRACH transmissions can be less than the specific number of multiple PRACH transmissions.

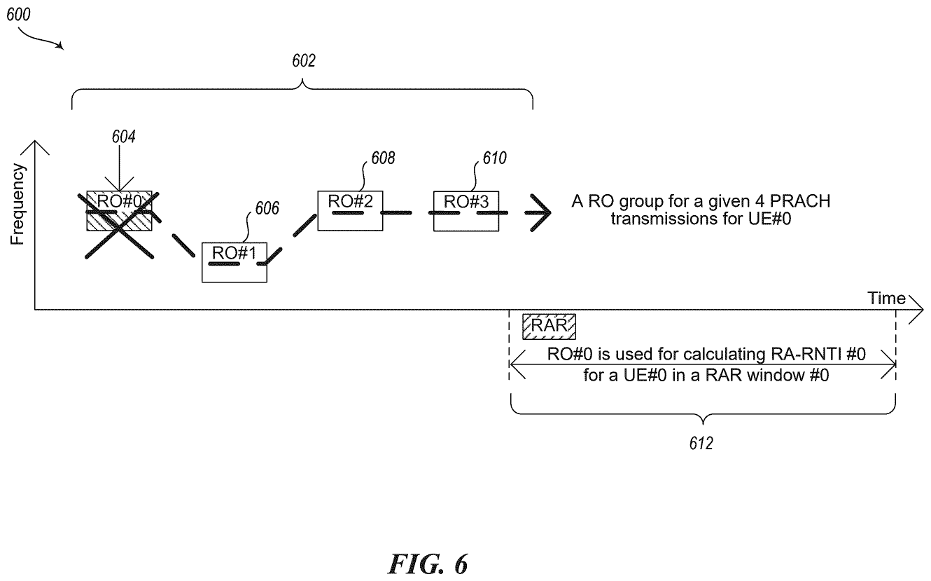

Currently, RA-RNTI calculation is based on the usage of one RO in a single-PRACH transmission until Rel. 18. For a multi-PRACH transmission, the existing approach can be extended to be reused based on the usage of one of the ROs in a RO group. A potential issue can be a misalignment between calculations of RA-RNTI at UE and gNB, such that it causes a failed decoding of RAR at the UE side. Consequently, increased power consumption may occur at the UE for a retransmission. There can be one or more reasons for the misalignment. One possible reason is that a gNB assumes that one of the ROs in the RO group is used for the RA-RNTI calculation, but the RO is dropped by the UE due to a RO collision. Hence, UE and gNB may calculate RA-RNTI candidates based on two different ROs. For example, referring to illustration 600 of FIG. 6, a UE may be provided a RO group 602 with a given 4 PRACH transmissions (with associated ROs 604, 606, 608 and 610), RO 604 may be used for RA-RNTI calculation for the UE in a RAR window 612, but RO 604 is dropped due to a RO collision such that only ROs 606, 608 and 610 are used for 3 actual PRACH transmissions. Thus, a gNB receiving the 3 actual PRACH transmissions may calculate RA-RNTI based on one of the ROs 606, 608 and 610 instead of RO 604. In another example, for a HD-UE in paired band, a gNB may not be aware of the number of valid ROs used for actual PRACH transmissions because of a HD-UE's implementation matters (since the number of valid ROs can be different between HD-UEs), and may end up calculating RA-RNTI based on a different RO. Another possible reason for the misalignment is that a UE may determine some valid ROs for actual PRACH transmissions, however one of the actual PRACH transmissions is unable to reach the gNB due to channel fading. The gNB may assume that the failed PRACH transmission in the corresponding RO is an invalid RO or a dropped RO. Hence, the UE and gNB may calculate RA-RNTI candidates based on two different ROs. It is thus necessary to specify a more robust approach to calculate a RA-RNTI for all types of UEs in both paired and unpaired bands to overcome the above issue.

In the present disclosure, a RO group may include at least one valid RO and zero or one or more invalid RO(s) for a specific N PRACH transmissions (e.g., a RO group may include at least one valid RO; or a RO group may include at least one valid RO and at least one invalid RO), and a RA-RNTI may be calculated regardless of the at least one valid RO and the zero or one or more invalid RO(s) for aligning the RA-RNTI calculation between UE and gNB based on one of the following three solutions: (Solution 1) RA-RNTI is calculated based on a RO, e.g., regardless of valid or invalid RO, in the RO group; (Solution 2) RA-RNTI is calculated based on a plurality of ROs from the at least one valid RO and the zero or one or more invalid RO(s) in the RO group; (Solution 3) RA-RNTI is calculated based on dedicated resources associated with the RO group. A valid RO is used for an actual PRACH transmission, while an invalid RO is not used for an actual PRACH transmission. The valid RO is identified after checking a RO dropping rule (or validation rule) for determining valid RO(s). The dedicated time and frequency domain resources are used for a purpose of RA-RNTI calculation, and they are not used for the specific N PRACH transmissions. Advantageously, it is possible to decode the corresponding RAR of multi-PRACH transmissions successfully even when a certain number of ROs in the RO group are dropped or one of actual PRACH transmissions in valid ROs is unable to reach the gNB. It will be appreciated that N can be configured as 2, 4, 8, 16, or 32 for supporting 2, 4, 8, 16, or 32 PRACH transmissions, respectively, and another value number of N is not precluded. N PRACH transmissions may be referred as a multiple PRACH transmissions, a multi-PRACH transmission, or one PRACH attempt of a multi-PRACH transmission.

Further, signalling for the RA-RNTI calculation (e.g., RA-RNTI calculation based on one of the Solutions 1-3) may be based on the following methods: (1) Method 1 is an explicit indication which may be used based on one or a combination of RRC signaling, MAC CE and DCI (e.g., an indication in SIB1/MIB is used); (2) Method 2 is that which one of the Solutions 1-3 should be used may be specified in the technical specifications; (3) Method 3 is an implicit indication which may be used, e.g., one of Solutions 1-3 may be assigned for each UE type. For example, Solution 1 may be assigned for a reduced capacity (RedCap) UE, while Solution 2 may be assigned to a non-RedCap UE, and other similar implementations or determinations or assignments. In this case, due to early identification of UE type at a gNB during initial access, it is possible for the gNB to determine which solution is used by a UE for RA-RNTI calculation. Accordingly, a UE may thus be configured to define an indication for the determination of one or more RA-RNTIs via a higher layer signaling, a MAC CE signaling, another DCI, or the determination of the one or more RA-RNTIs is pre-configured or specified in a technical specification.

For implementation of Solution 1, a base station may provide a control information indicating a plurality of ROs included in a RO group to a UE, e.g., by using higher layer signalling such as an RRC signalling. The plurality of ROs may be used for a multi PRACH transmission. A UE may receive the control information indicating a plurality of ROs included in a RO group, and the UE may calculate a RA-RNTI based on at least one RO in the RO group according to one of the following options 1-3. Then, the UE may transmit a preamble in one or more ROs in the RO group, the base station may receive the preamble and may calculate the RA-RNTI based on the at least one RO in the RO group. Further, the base station may transmit downlink control information (DCI) with cyclic redundancy check (CRC) scrambled by the RA-RNTI, and UE may receive the DCI. The UE attempts to detect the DCI. When the UE successfully decodes the DCI, it decodes the PDSCH carrying RAR. The calculation of RA-RNTI is known by both the UE and gNB.

In an Option 1, the RA-RNTI may be calculated based on a first RO (e.g., regardless of whether it is a valid or invalid RO) in the RO group. For example, even if a first RO of the RO group is an invalid RO, the RA-RNTI is calculated based on the invalid RO at the UE and at the base station. In other words, the indexes of time and frequency resources (e.g., s_id, t_id, f_id, and other similar index) of the first RO may be used in the equation for calculating the RA-RNTI. In this case, the preamble may not be transmitted in the first RO when it is invalid RO and may be transmitted in only a part of or all of valid ROs of the RO group. Option 1 can maintain a low signalling overhead. Further, when the first RO is a valid RO, Option 1 may be suitable for an early termination of a multi-PRACH transmission, where a UE can terminate the remaining PRACH transmissions in the remaining ROs (other than the first RO) if UE can receive RAR after the first PRACH transmission in the first RO, so that UE can save power consumption. In this case, a RAR window for the multi-PRACH transmission can start after the first RO in the RO group.

In an Option 2, the RA-RNTI may be calculated based on a n-th RO (e.g., regardless of whether it is a valid or invalid RO) in the RO group. For example, even if a n-th RO of the RO group is an invalid RO, the RA-RNTI is calculated based on the invalid RO at the UE and at the base station. In other words, the indexes of time and frequency resources (e.g., s_id, t_id, f_id and other similar index) of the n-th RO may be used in the equation for calculating the RA-RNTI. n may be greater than 1 and lesser than the total number of ROs in the RO group or n may be (pre-)configured, for example configured in a System Information Block Type 1 (SIB1) or a Master Information Block (MIB). In this case, the preamble may not be transmitted in the n-th RO if it is invalid RO and may be transmitted in only a part of or all of valid ROs of the RO group. In Option 2, gNB can have a more flexibility to configure which RO is to be used for the RA-RNTI calculation.

In an Option 3, the RA-RNTI may be calculated based on a last RO (e.g., regardless of whether it is a valid or invalid RO) in the RO group. For example, even if a last RO of the RO group is an invalid RO, the RA-RNTI is calculated based on the invalid RO at the UE and at the base station. In other words, the indexes of time and frequency resources (e.g., s_id, t_id, f_id and other similar index) of the last RO may be used in the equation for calculating the RA-RNTI. In this case, the preamble may not be transmitted in the last RO if it is invalid RO and may be transmitted in only a part of or all of valid ROs of the RO group. Option 3 can maintain a low signalling overhead. Further, Option 3 may be suitable for achieving a combined detection of a multi-PRACH transmission so that can improve performance gain of detection of preamble at gNB side. In this case, a RAR window for the multi-PRACH transmission can start after the last RO in the RO group. In addition, Option 3 requires a minimum impacts on current standards as compared to that of Option 1 and Option 2.

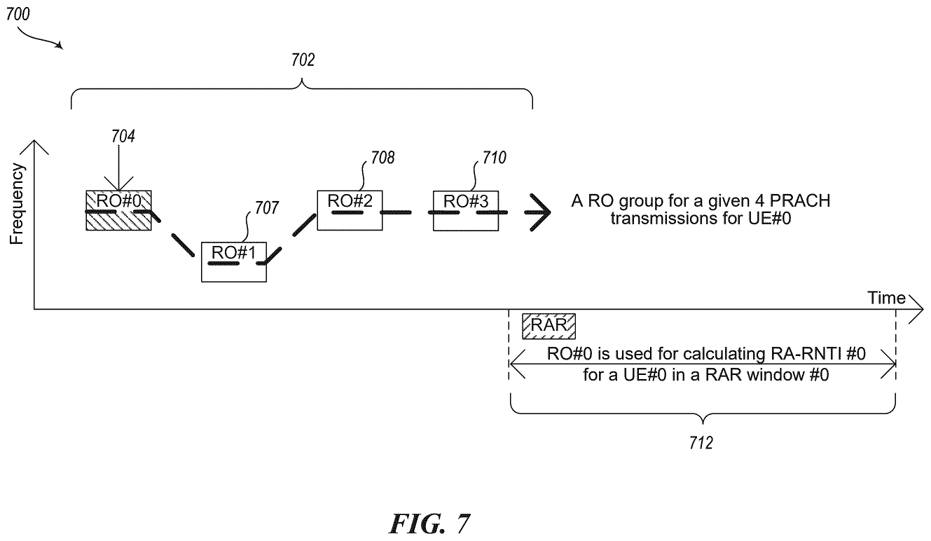

For example, referring to illustration 700 of FIG. 7, it is assumed that a UE is provided a RO group 702 including ROs 704, 706, 708 and 710 for a given 4 PRACH transmissions. After checking the RO dropping rule (or validation rule), it is determined that RO 704 is invalid, but ROs 706, 708 and 710 are valid. Since the RO on which RA-RNTI calculation is based can be a valid or an invalid RO in the RO group after checking the RO dropping rule, the RO to be used for RA-RNTI calculation for the UE in a RAR window 712 may be RO 704 by using Option 1, RO 708 by using Option 2 with n=3, or RO 710 by using Option 3. Advantageously, it is possible to reuse the existing equation for RA-RNTI calculation such that any impact to the current standards is minimized.

For implementation of Solution 2, a base station may provide a control information indicating a plurality of ROs included in a RO group to a UE, e.g., by using higher layer signalling such as an RRC signalling. The plurality of ROs may be used for a multi PRACH transmission. The UE may receive the control information indicating a plurality of ROs included in a RO group, and a RA-RNTI may be calculated based on one or more ROs from at least one valid RO and/or zero or one or more invalid RO(s) in the RO group at the UE and at the base station. A sum of time-domain resource indexes of the one or more ROs (e.g., M ROs, 1≤M≤N) and a sum of frequency-domain resource indexes of the one or more ROs in the RO group may be used to calculate the RA-RNTI. Then, the UE may transmit a preamble in one or more ROs in the RO group, the base station may receive the preamble and may calculate the RA-RNTI based on the at least one RO in the RO group. Further, the base station may transmit DCI with CRC scrambled by the RA-RNTI, and UE may receive the DCI. The UE attempts to detect the DCI. When the UE successfully decodes the DCI, it decodes the PDSCH carrying RAR. The calculation of RA-RNTI is known by both the UE and gNB.

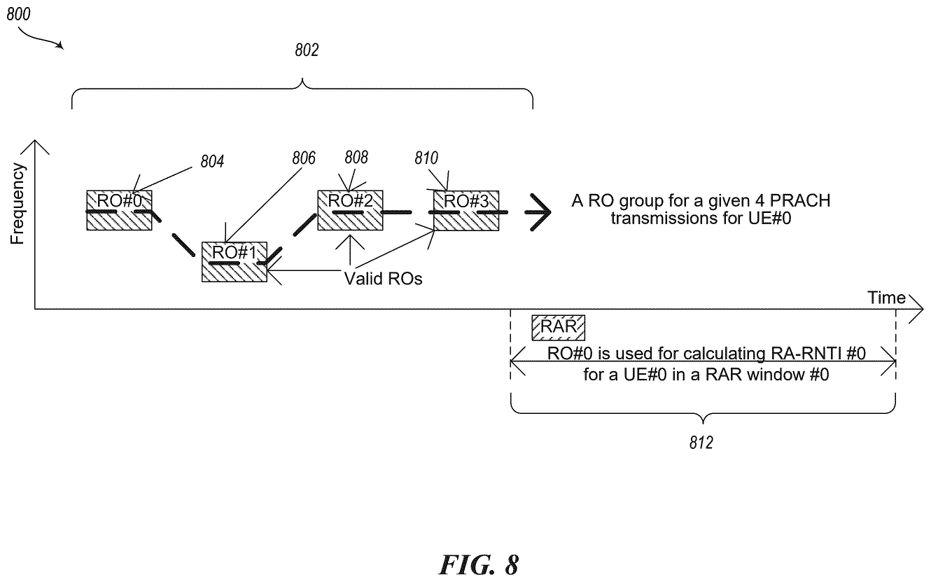

For example, referring to illustration 800 of FIG. 8, it is assumed that a UE is provided a RO group 802 including ROs 804, 806, 808 and 810 for a given 4 PRACH transmissions. After checking the RO dropping rule (or validation rule), it is determined that RO 804 is invalid, but ROs 806, 808 and 810 are valid. Since the RA-RNTI may be calculated based on one or more ROs from at least one valid RO and/or zero or one or more invalid RO(s) in the RO group, one or more of the ROs 804, 806, 808 and 810 may be used for the RA-RNTI calculation for the UE in a RAR window 812. In an implementation, a plurality of ROs (e.g., all the ROs 804, 806, 808 and 810) may be used for the RA-RNTI calculation. The RA-RNTI calculation may be expressed in the following equation RA-RNTI=1+s_id_sum+14×t_id_sum+14×80×f_id_sum+14×80×8×ul_carrier_id, where

$$s\_id \_sum = {\sum }_{i = 0}^{M - 1} s\_id \_i , t\_id \_sum = {\sum }_{i = 0}^{M - 1} t\_id \_i , f\_id \_sum = {\sum }_{i = 0}^{M - 1} f\_id \_i ,$$

i is the ordering of a RO, e.g., regardless of whether the RO is a valid or invalid RO, in the RO group, and M may be (pre-)configured, for example in a SIB1 or MIB. Further, s_id_i is the index of the first OFDM symbol of the i-th RO, t_id_i is the index of the first slot of the i-th RO, and f_id_i is the index of the i-th RO in the frequency domain. Alternatively, RA-RNTI may be calculated based on a subset of values of {s_id_sum, t_id_sum, f_id_sum, s_id_i, t_id_i, f_id_i}. For instance, the RA-RNTI calculation may be expressed in one of the following equations: (1) RA-RNTI=1+s_id_i+14×t_id_sum+14×80×f_id_i+14×80×8×ul_carrier_id; (2) RA-RNTI=1+s_id_sum+14×t_id_sum+14×80×f_id_i+14×80×8×ul_carrier_id; (3) RA-RNTI=1+s_id_sum+14×t_id+14×80×f_id_i+14×80×8×ul_carrier_id; (4) RA-RNTI=1+mod(s_id_sum, 14)+14×mod(t_id_sum, 80)+14×80×mod(f_id_sum,8)+14×80×8×ul_carrier_id, where mod(a, b) is a modulo operation or function such as a modulo b for the purpose that mod(s_id_sum, 14) does not exceed 14 as a maximum value as the legacy calculation, mod(t_id_sum,80) does not exceed 80 as a maximum value as the legacy calculation; and mod(f_id_sum,8) does not exceed 8 as a maximum value as the legacy calculation; (5) RA-RNTI=1+mod(s_id_sum, 14)+14×t_id_sum+14×80×f_id_i+14×80×8×ul_carrier_id; (6) RA-RNTI=1+s_id_i+14×mod(t_id_sum,80)+14×80×f_id_i+14×80×8×ul_carrier_id; (7) RA-RNTI=1+s_id_i+14×t_id_i+14×80×mod(f_id_sum, 8)+14×80×8×ul_carrier_id. It will be appreciated that the above RA-RNTI calculation includes an averaging operation based on the summation of {s_id_sum, t_id_sum, f_id_sum, s_id_i, t_id_i, f_id_i}. It will also be appreciated that the above RA-RNTI calculation can be expressed in a function of the one or more ROs from at least one valid RO and/or zero or one or more invalid RO(s) in the RO group. Advantageously, it is possible to reuse the existing equation for RA-RNTI calculation with a new range of values of the parameters (e.g., s_id_sum, t_id_sum, f_id_sum) such that any impact to the current standards is minimized. The Solution 2 introduces a different direction to calculate RA-RNTI for UE with capable of the multi-PRACH transmission. That is different from the legacy determination for legacy Rel. 15/16/17 UEs with capable of single PRACH transmission. This enables gNB to identify different capabilities of UEs (i.e., UE with capable of the multi-PRACH transmission and UE with capable of single PRACH transmission) so that gnB can have a better scheduling for different UE capabilities in the subsequence steps (e.g., Msg3 and Msg4) of the random access procedure.

For implementation of Solution 3, a base station may provide a control information indicating a plurality of ROs included in a RO group to a UE, e.g., by using higher layer signalling such as an RRC signalling. The plurality of ROs may be used for a multi PRACH transmission. The UE may receive the control information indicating a plurality of ROs included in a RO group, and a RA-RNTI may be calculated based on dedicated resources associated with the RO group (a dedicated resource per RO group) at the UE and at the base station. The dedicated resources associated with the RO group may only be used for a purpose of RA-RNTI calculation, e.g., a dedicated resource is used for calculating a RA-RNTI for an associated RO group. The dedicated resources may be separate resources, as compared to time and frequency domain resources of the at least one valid RO and zero or one or more invalid RO(s) in the RO group, and they may not be used for any PRACH transmission. The dedicated resources may be dedicated time and frequency domain resources, identification numbers, or assignment indexes, or non-zero values. The RA-RNTI calculation based on the dedicated resources may be expressed in the following equation: RA-RNTI=1+s_id_dedi+14×t_id_dedi+14×80×f_id_dedi+14×80×8×ul_carrier_id, where s_id_dedi, t_id_dedi, and f_id_dedi are indexes of dedicated time and frequency domain resources associated with the RO group. They are not related to indexes of the RO(s) in the RO group as shown in Solutions 1 and 2. The dedicated resources associated with a RO group may be (pre)-configured. For multiple RO groups, the dedicated time and frequency domain resources of each of multiple RO groups are different from each other.

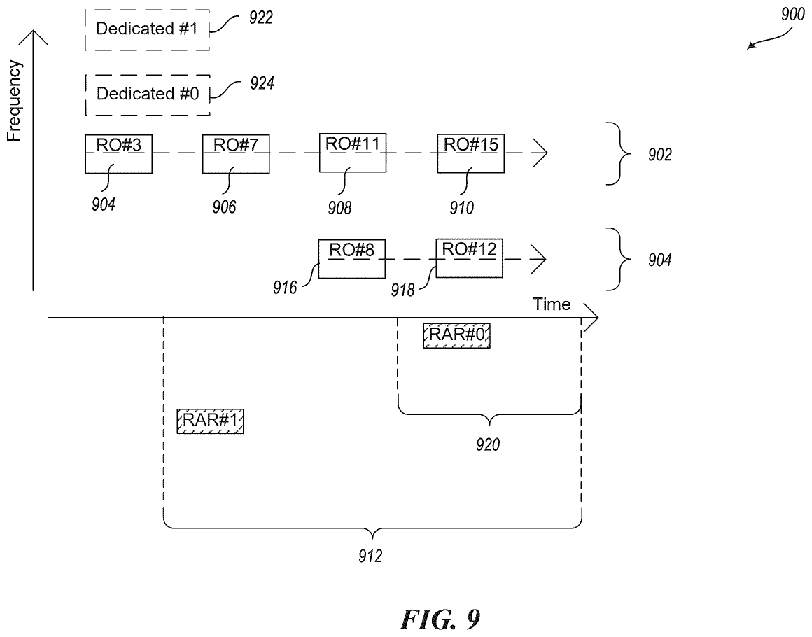

For example, referring to illustration 900 of FIG. 9, it is assumed that a first UE is provided a RO group 902 including ROs 904, 906, 908 and 910 for a given 4 PRACH transmissions, and a second UE is provided a RO group 914 including ROs 916 and 918 for a given 2 PRACH transmissions. Further, dedicated time and frequency domain resources 922 and 924 are associated with RO groups 902 and 914 respectively. Since the RA-RNTI may be calculated based on the dedicated resources associated with a RO group, the dedicated time and frequency domain resources 922 may be used for the RA-RNTI calculation for the first UE in a RAR window 912, and the dedicated time and frequency domain resources 924 may be used for the RA-RNTI calculation for the second UE in a RAR window 920. Since the dedicated time and frequency domain resources associated with a RO group can be pre-configured (e.g., a table-based indication comprising a list of dedicated time and frequency domain resources for all possible RO groups (for example, for 64 RO groups based on the number of preambles) supported in a serving cell), it advantageously does not introduce any additional signalling overhead for purposes of RA-RNTI calculation.

In an implementation, a RA-RNTI may be calculated based only on one or more valid RO(s) in a RO group (herein referred to as Solution 4). For example, a base station may provide a control information indicating a plurality of ROs included in a RO group to a UE, e.g., by using higher layer signalling such as an RRC signalling. The plurality of ROs may be used for a multi PRACH transmission. The UE may receive the control information indicating a plurality of ROs included in a RO group, and a RA-RNTI may be calculated at the UE and at the base station based only on one or more valid RO(s) in the RO according to one of the following options: in an option A, RA-RNTI is calculated based on a valid RO in the RO group (e.g., similar to Options 1-3 in Solution 1, but a valid RO is used for RA-RNTI calculation); in an option B, RA-RNTI is calculated based on a plurality of valid ROs in the RO group (e.g., similar to Solution 2, but a plurality of valid ROs is used for RA-RNTI calculation). Further, different UEs may determine different RA-RNTI candidates because a number of valid or invalid ROs can be different between UEs.

In an implementation, either Solutions 1-3 or Solution 4 may be used in a serving cell depending on a case-by-case basis: in a Case 1, for HD-UE in paired band in a serving cell, wherein it supports an “any RO counting” method (e.g., in a “any RO counting” method, for a given number of multiple PRACH transmissions, both valid RO(s) and invalid RO(s) in a RO group are counted, wherein a RO is identified as an invalid RO if it is not used for an actual PRACH transmission due to an RO dropping event, while valid RO(s) are used for actual PRACH transmissions) to formulate a RO group for a multi-PRACH transmission, one of Solutions 1-3 may be used; in a Case 2, for a serving cell supporting “valid RO only counting” method (e.g., in a “Valid RO only counting” method, for a given number of multiple PRACH transmissions, the counting is based only on valid RO(s) in a RO group, wherein valid RO(s) are used for actual PRACH transmissions) to formulate a RO group for a multi-PRACH transmission, Solution 4 is used. As an alternative solution to Case 1, a HD-UE may adjust SSB reception during the random access procedure for a multi-PRACH transmission (e.g., PRACH transmission in a RO has a higher priority than SSB reception during the random access procedure, such that the RO is not dropped (and is thus a valid RO) if there is a collision with SSB reception), so that Solution 4 can be used.

By using one of Solutions 1-3 or Solution 4, the RA-RNTI may be calculated commonly between UEs (including all types of UEs) in a serving cell. Further, one of Solutions 1-3 and Solution 4 may be configured based on UE type to calculate RA-RNTI in a serving cell, e.g., a solution is assigned for each UE type (e.g., for RedCap UE and for non-RedCap UE).

In an implementation, a RO group may include at least a valid RO and an invalid RO, and an RA-RNTI may be calculated based on at least the invalid RO. In Option 1 of Solution 1, as a variation, in a case that a first RO of a RO group is an invalid RO, the RA-RNTI may be calculated based on at least the invalid RO. In Option 2 of Solution 1, as a variation, in a case that a n-th RO of a RO group is an invalid RO, the RA-RNTI may be calculated based on at least the invalid RO. In Option 3 of Solution 1, as a variation, in a case that a last RO of a RO group is an invalid RO, the RA-RNTI may be calculated based on at least the invalid RO. Further, a combination of the parameters from Solutions 1, 2 and 3 can be used to calculate the RA-RNTI.

In an implementation, one of Solutions 1-4 can be applicable for both scenarios of a multi-PRACH transmission: (1) in scenario 1, the multi-PRACH transmission is sent by a UE with a usage of single antenna; (2) in scenario 2, the multi-PRACH transmission is sent by a UE with a usage of a plurality of antennas. In addition, one of Solutions 1-4 can be applied in both contention-based random access (CBRA) procedure and contention free random access (CFRA) procedure.

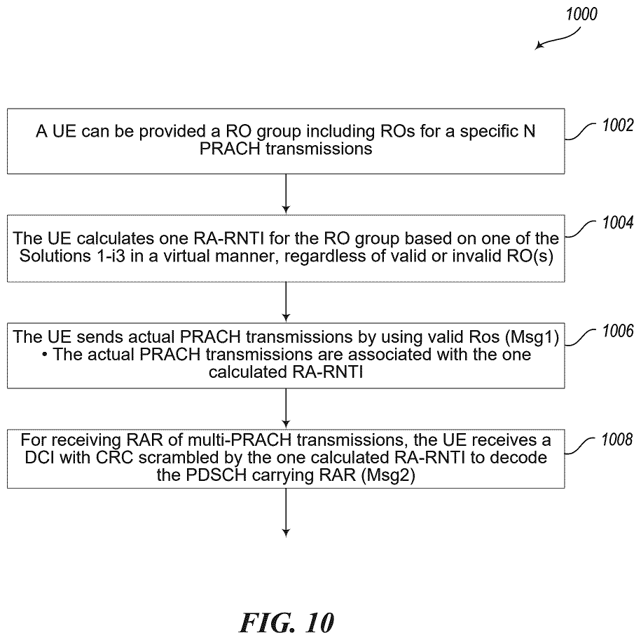

FIG. 10 shows a flow chart 1000 for a UE according to various embodiments of the present disclosure. In a step 1002, a UE may be provided with a RO group including a number of N ROs for a specific N PRACH transmissions. It will be appreciated that N can be configured as 2, 4, 8, 16, or 32 for supporting 2, 4, 8, 16, or 32 PRACH transmissions, respectively. The number of valid ROs for actual PRACH transmissions in a RO group can be less than or equal to N due to event(s) of RO collision. In a step 1004, the UE may calculate one RA-RNTI for the RO group based on one of the Solutions 1-3 in a virtual manner, regardless of valid or invalid RO(s). In a step 1006, the UE may send actual PRACH transmissions by using the valid RO(s) (e.g., Msg1 in a 4-step Random Access Channel (RACH) procedure). In a step 1008, the UE may receive a DCI with CRC scrambled by the calculated RA-RNTI to decode the PDSCH carrying RAR (e.g., Msg2 sent from a gNB in a 4-step RACH procedure), for receiving RAR of the multi-PRACH transmission.

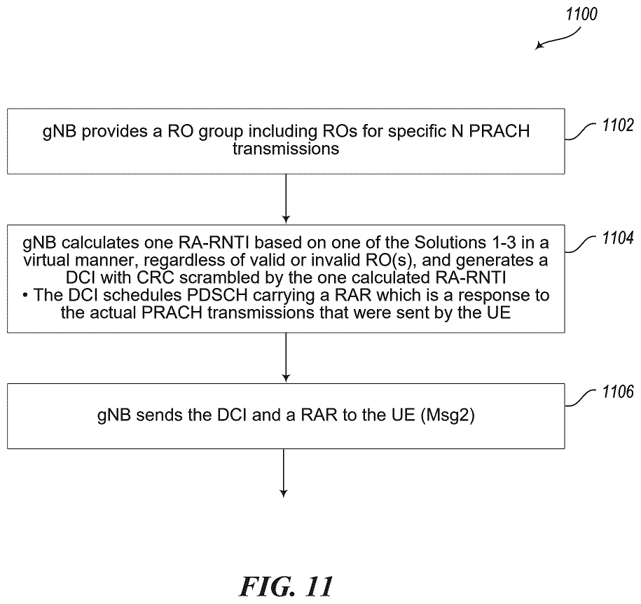

FIG. 11 shows a flow chart 1100 for a gNB according to various embodiments of the present disclosure. In a step 1102, a gNB may provide a RO group including ROs for a specific N PRACH transmissions. In a step 1104, the gNB may calculate one RA-RNTI based on one of the Solutions 1-3 in a virtual manner, regardless of valid or invalid RO(s). The gNB may generate a DCI with CRC scrambled by the calculated RA-RNTI. The DCI may schedule a PDSCH carrying a RAR which is a response to the actual PRACH transmissions that were sent by a UE. In a step 1106, the gNB may send the DCI that schedules PDSCH and the gNB may subsequently send PDSCH carrying a RAR to the UE (e.g., Msg2 in a 4-step RACH procedure).

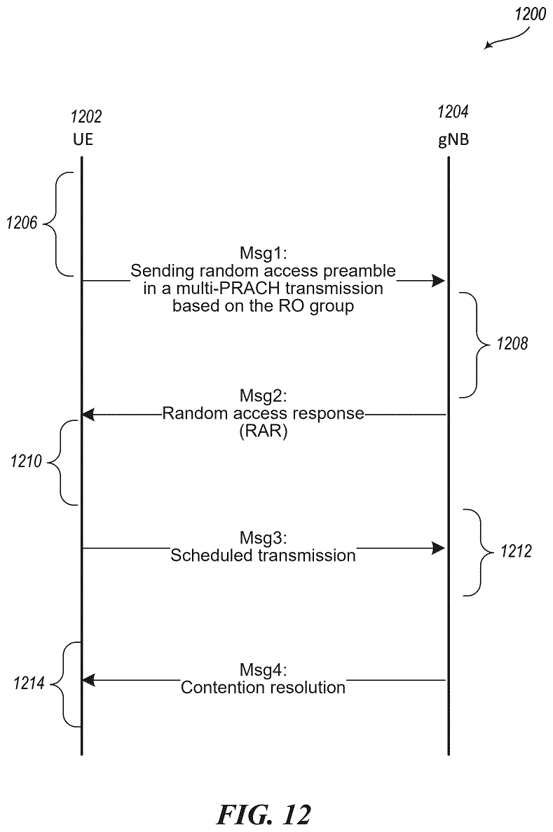

FIG. 12 shows an exemplary illustration of a 4-step random access (RA) procedure 1200 for a multi-PRACH transmission according to various embodiments of the present disclosure. In step 1206, a UE 1202 may calculate a RA-RNTI for a RO group based on one of the Solutions 1-3 in a virtual manner regardless of valid or invalid RO(s), and transmit a random access preamble via Msg 1 to a gNB 1204 It will be appreciated that the UE may calculate a RA-RNTI for a RO group before or after or during a process of sending the multi-PACH transmission. That is depending on either (i) a configuration from gNB to a UE for monitoring RAR in a RAR window, or (ii) implementation matter of the UE. The random access preamble in a multi-PRACH transmission is based on the RO group. In step 1208, the gNB 1204 may calculate a RA-RNTI based on one of the Solutions 1-3 in a virtual manner regardless of valid or invalid RO(s) in the RO group, and then transmits RAR on PDSCH (Msg 2) to the UE 1202 as a response to the multi-PRACH transmission. In particular, the gNB may generate a DCI, which schedules a PDSCH carrying the RAR, with CRC scrambled by its calculated RA-RNTI, and gNB subsequently may transmit the PDSCH carrying the RAR to the UE 1202. In step 1210, the UE may decode the DCI by using the RA-RNTI calculated by the UE in order to decode the PDSCH carrying RAR received from the gNB 1204. In step 1212, the UE may send Message 3 (Msg3) PUSCH to the gNB 1204. In step 1214, the gNB 1204 may transmit Message 4 (Msg 4) (e.g., PDCCH/PDSCH) to the UE 1202.

Though the above procedure 1200 is illustrated in a 4-step RACH procedure in a contention based random access (CBRA), it will be appreciated that the present disclosure (e.g., Solutions 1-3, flowcharts 1000 and 1100) may also be implemented in a 2-step RACH procedure or in a 4-step RACH procedure in a contention-free random access (CFRA).

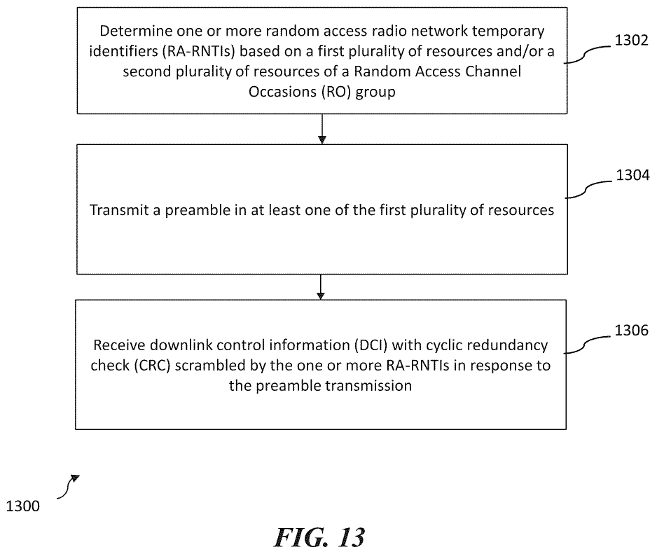

FIG. 13 shows a flow chart 1300 illustrating a communication method according to various embodiments of the present disclosure. At step 1302, one or more random access radio network temporary identifiers (RA-RNTIs) may be determined based on a first plurality of resources and/or a second plurality of resources of a Random Access Channel Occasions (RO) group. At step 1304, a preamble may be transmitted in at least one of the first plurality of resources. At step 1306, downlink control information (DCI) with cyclic redundancy check (CRC) scrambled by the one or more RA-RNTIs may be received in response to the preamble transmission.

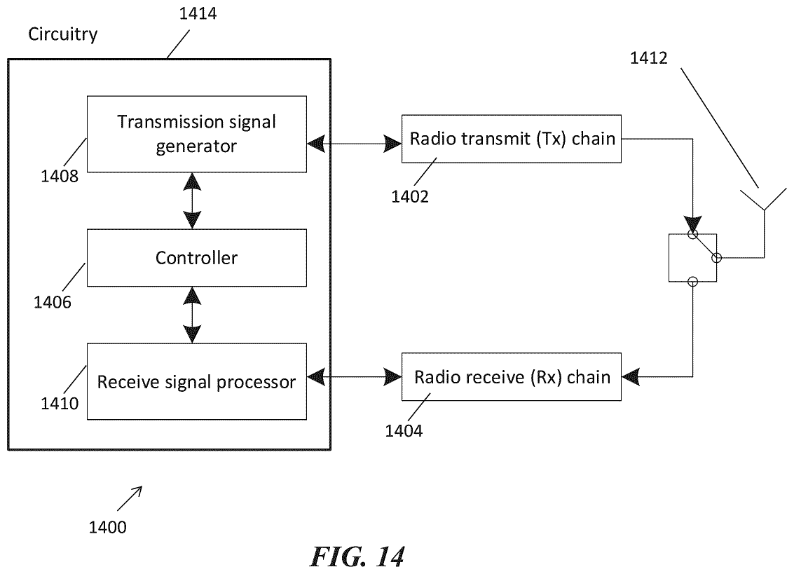

FIG. 14 shows a schematic, partially sectioned view of the communication apparatus 1400 that can be implemented for in accordance with various embodiments and examples as shown in FIGS. 1 to 13. The communication apparatus 1400 may be implemented as a UE or base station according to various embodiments.

Various functions and operations of the communication apparatus 1400 are arranged into layers in accordance with a hierarchical model. In the model, lower layers report to higher layers and receive instructions therefrom in accordance with 3GPP technical specifications. For the sake of simplicity, details of the hierarchical model are not discussed in the present disclosure.

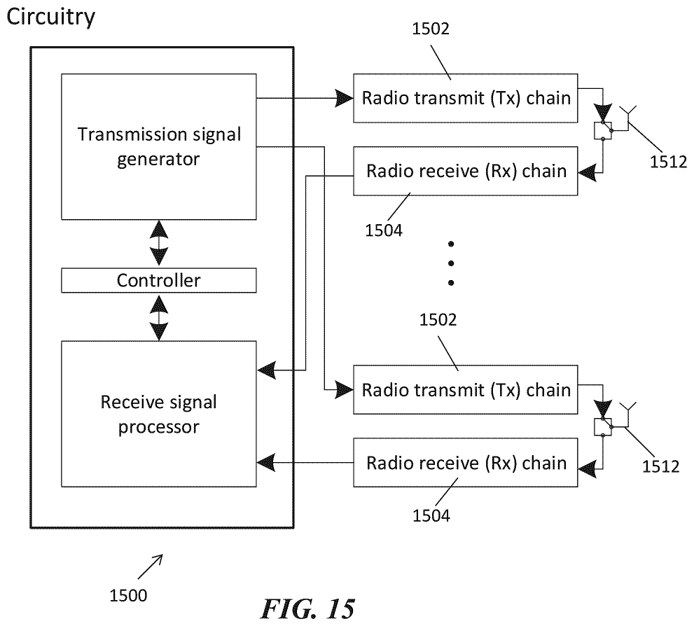

As shown in FIG. 14, the communication apparatus 1400 may include circuitry 1414, at least one radio transmit (Tx) chain 1402 (also referred to herein as transmitter 1402), at least one radio receive (Rx) chain 1404 (also referred to herein as receiver 1404), and at least one antenna 1412 (for the sake of simplicity, only one antenna is depicted in FIG. 14 for illustration purposes). The circuitry 1414 may include at least one controller 1406 for use in software and hardware aided execution of tasks that the at least one controller 1406 is designed to perform, including control of communications with one or more other communication apparatuses in a wireless network. The circuitry 1414 may furthermore include at least one transmission signal generator 1408 and at least one receive signal processor 1410. The at least one controller 1406 may control the at least one transmission signal generator 1408 for generating signals to be sent through the at least one radio transmitter 1402 to one or more other communication apparatuses and the at least one receive signal processor 1410 for processing signals received through the at least one radio receiver 1404 from the one or more other communication apparatuses under the control of the at least one controller 1406. The at least one transmission signal generator 1408 and the at least one receive signal processor 1410 may be stand-alone modules of the communication apparatus 1400 that communicate with the at least one controller 1406 for the above-mentioned functions as shown in FIGS. 1-13. Alternatively, the at least one transmission signal generator 1408 and the at least one receive signal processor 1410 may be included in the at least one controller 1406. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1402, at least one radio receiver 1404, and at least one antenna 1412 may be controlled by the at least one controller 1406. It will be appreciated that the communication apparatus 1400 may include a plurality of antennas, for example as shown in communication apparatus 1500 of FIG. 15 which includes a plurality of antennas 1512. Each of the plurality of antennas 1512 can be connected to a corresponding Tx chain 1502 and Rx chain 1504 through a switcher or switch point. Alternatively, each of the plurality of antennas 1512 can be connected to a corresponding Tx chain or Rx chain.

The communication apparatus 1400, when in operation, provides functions required for RA-RNTI calculation for handling RO collision in a multi-PRACH transmission. For example, the communication apparatus 1400 may be a UE, and the circuitry 1414 may, in operation, determine one or more random access radio network temporary identifiers (RA-RNTIs) based on a first plurality of resources and/or a second plurality of resources of a Random Access Channel Occasions (RO) group. The transmitter 1402 may, in operation, transmit a preamble in at least one of the first plurality of resources. The receiver 1404 may, in operation, receive downlink control information (DCI) with cyclic redundancy check (CRC) scrambled by the one or more RA-RNTIs in response to the preamble transmission.

The first plurality of resources may be a plurality of radio resources of a plurality of ROs in the RO group. The plurality of ROs may comprise at least one valid RO and at least one invalid RO, and the circuitry 1414 may be configured to determine the one or more RA-RNTIs based on at least one radio resource of the at least one invalid RO in the first plurality of resources.

A n-th RO of the plurality of ROs may be a valid RO or an invalid RO, and n may be an integer within a range of 1 to a total number of the plurality of ROs, and the circuitry 1414 may be configured to determine the one or more RA-RNTIs based on at least one radio resource of the n-th RO. n may be indicated by a higher layer signaling, a MAC CE signaling, another DCI, or pre-configured or defined in a technical specification.

All ROs in the plurality of ROs may be valid ROs, or the plurality of ROs may comprise at least one valid RO and at least one invalid RO. The circuitry 1414 may be configured to determine the one or more RA-RNTIs based on two or more radio resources of only valid ROs in the first plurality of resources, or based on two or more radio resources of at least one valid RO and at least one invalid RO in the first plurality of resources.

The second plurality of resources may be a plurality of dedicated resources associated with the RO group, and the circuitry 1414 may be configured to determine the one or more RA-RNTIs based on the plurality of dedicated resources. The plurality of dedicated resources may comprise specific radio resources that are separate from radio resources of a plurality of ROs in the RO group, or identification numbers, assignment indexes, or non-zero values.

The circuitry 1414 may be configured to determine the one or more RA-RNTIs based on a serving cell associated with the communication apparatus. The circuitry 1414 may be further configured to determine the one or more RA-RNTIs based on a type of the communication apparatus. The circuitry 1414 may be further configured to define an indication for the determination of the one or more RA-RNTIs via a higher layer signaling, a MAC CE signaling, another DCI, or the determination of the one or more RA-RNTIs is pre-configured or specified in a technical specification.

The circuitry 1414 may be configured to determine the one or more RA-RNTIs based on a function of the first plurality of resources and/or the second plurality of resources, the function being indicated by a higher layer signaling, MAC CE signaling, downlink control information (DCI), or specified in a technical specification. The circuitry 1414 may be configured to determine the one or more RA-RNTIs based on a subset of the first plurality of resources and/or the second plurality of resources, the subset being indicated by a higher layer signaling, MAC CE signaling, downlink control information (DCI), or specified in a technical specification. The circuitry 1414 may be further configured to decode a Physical Downlink Shared Channel (PDSCH) carrying Random Access Response (RAR) based on the determined one or more RA-RNTIs.

The communication apparatus 1400 may be a first communication apparatus, and the receiver 1404 may, in operation, receive a preamble in at least one of a first plurality of resources of a Random Access Channel Occasions (RO) group from a second communication apparatus. The circuitry 1414 may, in operation, determine one or more random access radio network temporary identifiers (RA-RNTIs) based on the first plurality of resources and/or a second plurality of resources, and generate a downlink control information (DCI) with cyclic redundancy check (CRC) scrambled by the one or more RA-RNTIs. The transmitter 1402 may, in operation, transmit the DCI to the second communication apparatus.

### (Control Signals)

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the first stage sidelink control information (SCI) or the second stage SCI.

### (Base Station)

In the present disclosure, the base station may be a Transmission Reception Point (TRP), a cluster head, an access point, a Remote Radio Head (RRH), an eNodeB (eNB), a gNodeB (gNB), a Base Station (BS), a Base Transceiver Station (BTS), a base unit or a gateway, for example. Further, in sidelink communication, a terminal may be adopted instead of a base station. The base station may be a relay apparatus that relays communication between a higher node and a terminal. The base station may be a roadside unit as well.

### (Uplink/Downlink/Sidelink)

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### (Data Channels/Control Channels)

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### (Reference Signals)

In the present disclosure, the reference signals are signals known to both a base station and a mobile station and each reference signal may be referred to as a Reference Signal (RS) or sometimes a pilot signal. The reference signal may be any of a DMRS, a Channel State Information—Reference Signal (CSI-RS), a Tracking Reference Signal (TRS), a Phase Tracking Reference Signal (PTRS), a Cell-specific Reference Signal (CRS), and a Sounding Reference Signal (SRS).

### (Time Intervals)

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### (Frequency Bands)

The present disclosure may be applied to any of a licensed band and an unlicensed band.

### (Communication)

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### (Antenna Ports)

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

As described above, the embodiments of the present disclosure provide an advanced communication system, communication methods and communication apparatuses that advantageously perform RA-RNTI calculation for handling RO collision in a multi-PRACH transmission.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

Some non-limiting examples of such communication apparatus include a phone (e.g., cellular (cell) phone, smart phone), a tablet, a personal computer (PC) (e.g., laptop, desktop, netbook), a camera (e.g., digital still/video camera), a digital player (e.g., digital audio/video player), a wearable device (e.g., wearable camera, smart watch, tracking device), a game console, a digital book reader, a telehealth/telemedicine (e.g., remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

The present disclosure may refer to the following statements:
Statement 1. A communication apparatus comprising:
   circuitry, which in operation, determines one or more random access radio network temporary identifiers (RA-RNTIs) based on a first plurality of resources and/or a second plurality of resources of a Random Access Channel Occasions (RO) group;
   a transmitter, which in operation, transmits a preamble in at least one of the first plurality of resources; and
   a receiver, which in operation, receives downlink control information (DCI) with cyclic redundancy check (CRC) scrambled by the one or more RA-RNTIs in response to the preamble transmission.
      An advantage of this feature is to enable the UE to decode the corresponding RAR of multi-PRACH transmissions successfully even when a certain number of ROs in the RO group can be dropped or one of actual PRACH transmissions in valid ROs cannot be reached to gNB.
Statement 2. The communication apparatus of Statement 1, wherein the first plurality of resources is a plurality of radio resources of a plurality of ROs in the RO group.
   An advantage of this feature is to enable a UE to know which resource is to be used for the RA-RNTI calculation.
Statement 3. The communication apparatus of Statement 2, wherein the plurality of ROs comprises at least one valid RO and at least one invalid RO, and the circuitry is configured to determine the one or more RA-RNTIs based on at least one radio resource of the at least one invalid RO in the first plurality of resources.
   An advantage of this feature is to reuse the existing equation of RA-RNTI calculation in order to minimize standard impact.
Statement 4. The communication apparatus of Statement 2, wherein a n-th RO of the plurality of ROs is a valid RO or an invalid RO, and n is an integer within a range of 1 to a total number of the plurality of ROs, and the circuitry is configured to determine the one or more RA-RNTIs based on at least one radio resource of the n-th RO in the first plurality of resources.
   An advantage of this feature is to reuse the existing equation of RA-RNTI calculation in order to minimize standard impact.
Statement 5. The communication apparatus of Statement 4, wherein n is indicated by a higher layer signaling, a MAC CE signaling, another DCI, or pre-configured or defined in a technical specification.
   An advantage of this feature is to get more flexibility in configuration of the RA-RNTI calculation, where it is based on the signaling of n.
Statement 6. The communication apparatus of Statement 2, wherein all ROs in the plurality of ROs are valid ROs, or the plurality of ROs comprise at least one valid RO and at least one invalid RO.
   An advantage of this feature is to reuse the existing equation of RA-RNTI calculation in order to minimize standard impact.
Statement 7. The communication apparatus of Statement 6, wherein the circuitry is configured to determine the one or more RA-RNTIs based on two or more radio resources of only valid ROs in the first plurality of resources, or based on two or more radio resources of at least one valid RO and at least one invalid RO in the first plurality of resources.
   An advantage of this feature is to reuse the existing equation of RA-RNTI calculation with new range values for parameters (e.g., s_id_sum, t_id_sum, f_id_sum) in order to minimize standard impact.
Statement 8. The communication apparatus of Statement 2, wherein the second plurality of resources is a plurality of dedicated resources associated with the RO group, and the circuitry is configured to determine the one or more RA-RNTIs based on the plurality of dedicated resources.
   Since the dedicated resources of the RO group can be pre-configured (e.g., a table-based indicates a list of dedicated time and frequency domain resources for all possible RO groups (e.g., 64 as a maximum number of preambles that can be supported in a serving cell currently) supported in a serving cell), it does not introduce any additional signalling overhead for a purpose of RA-RNTI calculation.
Statement 9. The communication apparatus of Statement 8, wherein the plurality of dedicated resources comprises specific radio resources that are separate from radio resources of a plurality of ROs in the RO group, or identification numbers, assignment indexes, or non-zero values.
   Since the dedicated resources of the RO group can be pre-configured (e.g., a table-based indicates a list of dedicated time and frequency domain resources for all possible RO groups (e.g., 64 as a maximum number of preambles that can be supported in a serving cell currently) supported in a serving cell), it does not introduce any additional signalling overhead for a purpose of RA-RNTI calculation.
Statement 10. The communication apparatus of Statement 1, wherein circuitry is configured to determine the one or more RA-RNTIs based on a serving cell associated with the communication apparatus.
   The determination of the one or more RA-RNTIs among UEs based on a serving cell advantageously (i.e., a cell-specific method for the determination of the one or more RA-RNTIs among UEs in a serving cell) minimizes complexity of gNB in term of configuration and implementation.
Statement 11. The communication apparatus of any one of Statement 1 or 10, wherein the circuitry is configured to determine the one or more RA-RNTIs based on a type of the communication apparatus.
   An advantage of this feature is to allow more flexibility of a gNB to configure different method for the determination of the one or more RA-RNTIs among UE types.
Statement 12. The communication apparatus of Statement 1, wherein the circuitry is configured to define an indication for the determination of the one or more RA-RNTIs via a higher layer signaling, a MAC CE signaling, another DCI, or the determination of the one or more RA-RNTIs is pre-configured or specified in a technical specification.
   An advantage of this feature is to enable a UE to decide which solution/method to be used for the determination of the one or more RA-RNTIs.
Statement 13. The communication apparatus of Statement 1, wherein the circuitry is configured to determine the one or more RA-RNTIs based on a function of the plurality of resources and/or the second plurality of resources, the function being indicated by a higher layer signaling, MAC CE signaling, downlink control information (DCI), or specified in a technical specification.
   An advantage of this feature is to define a specific function of the determination of the one or more RA-RNTIs for the case of multi-PRACH transmission.
Statement 14. The communication apparatus of Statement 1, wherein the circuitry is configured to determine the one or more RA-RNTIs based on a subset of the first plurality of resources and/or the second plurality of resources, the subset being indicated by a higher layer signaling, MAC CE signaling, downlink control information (DCI), or specified in a technical specification.
   An advantage of this feature is to have more choices of possibilities of the determination of the one or more RA-RNTIs.
Statement 15. The communication apparatus of Statement 1, wherein the circuitry is further configured to decode a Physical Downlink Shared Channel (PDSCH) carrying Random Access Response (RAR) based on the determined one or more RA-RNTIs.
   An advantage of this feature is to enable the UE to decode the corresponding RAR of a multi-PRACH transmission so that (i) the UE understands that the multi-PRACH transmission was reached a gNB successfully and (ii) the UE knows which radio resources are to be used for a subsequence PUSCH transmission (aka Message 3 (Msg3)) in the random access procedure.
Statement 16. A first communication apparatus comprising:
   a receiver, which in operation, receives a preamble in at least one of a first plurality of resources of a Random Access Channel Occasions (RO) group from a second communication apparatus;
   circuitry, which in operation, determines one or more random access radio network temporary identifiers (RA-RNTIs) based the first plurality of resources and/or a second plurality of resources, and generates a downlink control information (DCI) with cyclic redundancy check (CRC) scrambled by the one or more RA-RNTIs; and
   a transmitter, which in operation, transmits the DCI to the second communication apparatus.
      An advantage of this feature is to enable the UE to decode the corresponding RAR of multi-PRACH transmissions successfully even when a certain number of ROs in the RO group can be dropped or one of actual PRACH transmissions in valid ROs cannot be reached to gNB.
Statement 17. A communication method comprising:
   determining one or more random access radio network temporary identifiers (RA-RNTIs) based on a first plurality of resources and/or a second plurality of resources of a Random Access Channel Occasions (RO) group;
   transmitting a preamble in at least one of the first plurality of resources; and
   receiving a downlink control information (DCI) with cyclic redundancy check (CRC) scrambled by the one or more RA-RNTIs in response to the preamble transmission.
      An advantage of this feature is to enable the UE to decode the corresponding RAR of multi-PRACH transmissions successfully even when a certain number of ROs in the RO group can be dropped or one of actual PRACH transmissions in valid ROs cannot be reached to gNB.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1-17. (canceled)

18. A communication apparatus, comprising:
circuitry, which, in operation, determines a random access radio network temporary identifier (RA-RNTI) based on a valid Random Access Channel Occasion (RO) within a first RO group, the first RO group being determined from a plurality of ROs including valid ROs and invalid ROs;
a transmitter, which, in operation, transmits repetitions of a preamble on at least one RO of the first RO group; and
a receiver, which, in operation, receives downlink control information (DCI) with cyclic redundancy check (CRC) scrambled by the RA-RNTI in response to a transmission of the repetitions of the preamble.

19. The communication apparatus of claim 18, wherein the RA-RNTI is determined based on a time index and a frequency index of a valid RO.

20. The communication apparatus of claim 18, wherein ROs within the first RO group are assigned in a same frequency.

21. The communication apparatus of claim 18, wherein a frequency of ROs within the first RO group is different from a frequency of another ROs within a second RO group.

22. The communication apparatus of claim 18, wherein a number of only valid ROs in the first RO group is counted for a number of the repetitions of the preamble.

23. The communication apparatus of claim 22, wherein the number of the repetitions of the preamble is configured from a plurality values.

24. A communication method comprising:
determining a random access radio network temporary identifier (RA-RNTI) based on a valid Random Access Channel Occasion (RO) within a first RO group, the first RO group being determined from a plurality of ROs including valid ROs and invalid ROs;
transmitting repetitions of a preamble on at least one RO of the first RO group; and
receiving downlink control information (DCI) with cyclic redundancy check (CRC) scrambled by the RA-RNTI in response to a transmission of the repetitions of the preamble.

25. The communication method of claim 24, wherein the RA-RNTI is determined based on a time index and a frequency index of a valid RO.

26. The communication method of claim 24, wherein ROs within the first RO group are assigned in a same frequency.

27. The communication method of claim 24, wherein a frequency of ROs within the first RO group is different from a frequency of another ROs within a second RO group.

28. The communication method of claim 24, wherein a number of only valid ROs in the first RO group is counted for a number of the repetitions of the preamble.

29. The communication method of claim 28, wherein the number of the repetitions of the preamble is configured from a plurality values.

30. An integrated circuit, comprising:
determination circuitry, which, in operation, controls a determination of a random access radio network temporary identifier (RA-RNTI) based on a valid Random Access Channel Occasion (RO) within a first RO group, the first RO group being determined from a plurality of ROs including valid ROs and invalid ROs;
transmission circuitry, which, in operation, controls a transmission of repetitions of a preamble on at least one of the plurality of ROs; and
reception circuitry, which, in operation, controls a reception of downlink control information (DCI) with cyclic redundancy check (CRC) scrambled by the RA-RNTI in response to the transmission of the repetitions of the preamble.
